(19) United States
(12) Patent Application Publication
(10) Pub. No.: US 2025/0322611 A1
(43) Pub. Date: Oct. 16, 2025

(54) INFORMATION PROCESSING DEVICE

(71) Applicant: NTT DOCOMO, INC., Tokyo (JP)

(72) Inventor: Hiroyuki FUJINO, Tokyo (JP)

(21) Appl. No.: 18/869,928

(22) PCT Filed: Apr. 12, 2023
(86) PCT No.: PCT/JP2023/014857

§ 371 Date: Nov. 27, 2024

(30) Foreign Application Priority Data
May 30, 2022 (JP) 2022-087984

(51) Int. Cl. G06T 19/00

(52) U.S. Cl. CPC G06T 19/00

(57) ABSTRACT

Attention position specifying unit specifies attention positions to which users pay attention in a virtual space, based on detection results of users' lines of sight acquired by acquisition unit, and three-dimensional coordinates in the virtual space displayed on head-mounted displays of the users at the time of detection of the lines of sight. Non-attention object extraction unit extracts as a non-attention object, from virtual objects included in the virtual space, a virtual object for which a number of times the virtual object is specified as an attention position does not meet a criterion. Data reduction unit reduces an amount of polygon data for displaying the non-attention object extracted by non-attention object extraction unit.

### TECHNICAL FIELD

The present invention relates to a technique for displaying a virtual object.

### BACKGROUND

XR (cross reality) is a collective term used for techniques for combining the real world and a virtual world to enable perception of elements that are not present in reality, and includes techniques of VR (virtual reality), AR (augmented reality), and MR (mixed reality). In realizing XR, a display terminal such as a head-mounted display (HMD) performs processing for acquiring and rendering polygon data that has three-dimensional coordinates in a virtual three-dimensional space, in order to display various virtual objects.

A processing load from acquisition to rendering of such polygon data is significant, and thus there is the possibility that a delay may occur in displaying such data. In view of this, for example, according to JP 2019-197224A, smooth display is realized by displaying a segment to which a user is paying attention at a higher resolution than other segments in the HMD.

### SUMMARY OF INVENTION

It is envisioned that a plurality of users joins a three-dimensional virtual space, referred to as a “metaverse” or “cyberspace,” using representations of themselves as “avatars” to communicate and engage in activities with each other, while living a new life using the space as another “reality.”

An object of the present invention is to provide a mechanism for smoothly displaying a plurality of virtual objects in a virtual space in which a plurality of users can participate.

To solve the aforementioned problem, the present invention provides an information processing apparatus including: an attention-position specifying unit that specifies, in a virtual space that includes virtual objects displayed on user terminals, an attention position to which users using the user terminals pay attention; a non-attention object extraction unit that extracts as a non-attention object from the virtual objects, a virtual object for which a number of times of being specified as the attention position does not meet a criterion; and a data reduction unit that reduces an amount of data for displaying the extracted non-attention object on the user terminals.

According to the present invention, a plurality of virtual objects can be smoothly displayed in a virtual space in which a plurality of users can participate.

### BRIEF DESCRIPTION OF DRAWINGS

FIG. 1 is a diagram illustrating a configuration of information processing system 1 according to an embodiment of the present invention.

FIG. 2 is a block diagram showing an example of a hardware configuration of head-mounted display 10 according to the embodiment.

FIG. 3 is a block diagram showing an example of a hardware configuration of server apparatus 20 according to the embodiment.

FIG. 4 is a block diagram showing an example of a functional configuration of server apparatus 20.

FIG. 5 is a diagram illustrating count data on a number of times of attention stored in server apparatus 20.

FIG. 6 is a diagram illustrating a data reduction table stored in server apparatus 20.

FIG. 7 is a flowchart showing an example of an operation of updating the number of times of attention that is performed by server apparatus 20.

FIG. 8 is a flowchart showing an example of a data delivering operation that is performed by server apparatus 20.

FIG. 9 is a diagram illustrating the distribution of positions of attention in a display image on head-mounted display 10.

FIG. 10 is a diagram illustrating a display image after data reduction performed in head-mounted display 10.

FIG. 11 is a diagram illustrating count data on the number of times of attention according to a modification of the present invention.

FIG. 12 is a diagram illustrating count data on the number of times of attention according to a modification of the present invention.

FIG. 13 is a diagram illustrating count data on the number of times of attention according to a modification of the present invention.

### DETAILED DESCRIPTION

### Configuration

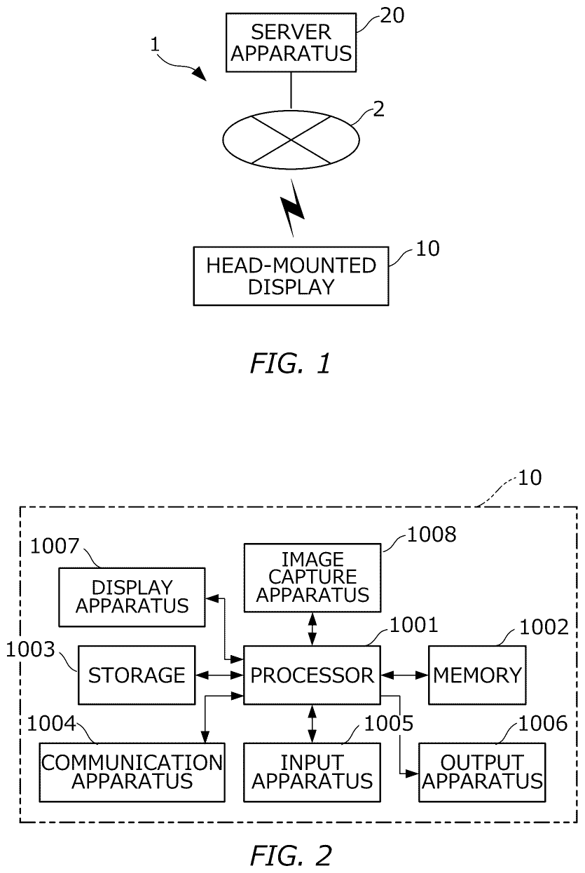

FIG. 1 is a diagram showing an example of information processing system 1 according to an embodiment of the present invention. Information processing system 1 includes a plurality of head-mounted displays 10 that are respectively used by a plurality of users and server apparatus 20 that provides data for realizing XR to the head-mounted displays 10. Server apparatus 20 and head-mounted displays 10 are communicably connected to each other by network 2. Network 2 is a LAN (Local Area Network), a WAN (Wide Area Network), or a combination thereof, for example, and includes a wired section or wireless section. Each head-mounted display 10 functions as a user terminal according to the present invention. Server apparatus 20 functions as an information processing apparatus according to the present invention. In the present embodiment, a case will be described where VR (virtual reality) is realized as an example of XR. That is to say, each head-mounted display 10 displays various virtual objects in a three dimensional virtual space.

In the present embodiment, each head-mounted display 10 is illustrated as a user terminal that is mounted on the head of a user. Note that the user terminal is not limited to the example of the present embodiment, and may be a wearable computer such as a glasses-type or contact lens-type computer, or may also be a computer such as a smartphone or a tablet.

FIG. 2 is a diagram illustrating a hardware configuration of head-mounted display 10. Head mounted display 10 is configured as a computer including processor 1001, memory 1002, storage 1003, communication apparatus 1004, input apparatus 1005, output apparatus 1006, display apparatus 1007, image capture apparatus 1008, a bus connecting these components, and so on. Note that, in the following description, the term “apparatus” may mean a circuit, device, unit, or the like. The hardware configuration of head-mounted display 10 may include one or more of each of the apparatuses shown in the figure, but need not include all of the apparatuses.

Each function of head-mounted display 10 is realized by loading predetermined software (programs) into hardware such as processor 1001 and memory 1002 so that processor 1001 performs processes to control communication performed by communication apparatus 1004, to control display performed by display apparatus 1007, to control image capture performed by image capture apparatus 1008, and to control at least one of reading data from and writing data to memory 1002 and storage 1003.

Processor 1001 runs an operating system to control the entire computer, for example. Processor 1001 may be constituted of a central processing unit (CPU) that includes an interface with a peripheral apparatus, a control apparatus, a computation apparatus, a register, and so on. In addition, for example, a baseband signal processing unit, a call processing unit, and so on may be realized by processor 1001.

Processor 1001 reads out programs (program codes), software modules, data, and so on from at least one of storage 1003 and communication apparatus 1004 into memory 1002 and performs various kinds of processing in accordance with the programs. Programs that enable a computer to execute at least some of the operations described below are used as the aforementioned programs. The functional blocks of head-mounted display 10 may be realized by control programs stored in memory 1002 and executed by processor 1001. The various kinds of processing may be performed by a single processor 1001, but may also be performed by two or more processors 1001 either simultaneously or sequentially. Processor 1001 may be implemented using one or more chips. The programs may be transmitted to head-mounted display 10 via network 2.

Memory 1002 is a computer-readable recording medium, and may be constituted by at least one of a ROM (Read Only Memory), an EPROM (Erasable Programmable ROM), an EEPROM (Electrically Erasable Programmable ROM), a RAM (Random Access Memory), and so on. Memory 1002 may also be referred to as a register, a cache, a main memory (main storage apparatus), or the like. Memory 1002 is capable of storing executable programs (program codes), software modules, and so on to implement the method according to the present embodiment.

Storage 1003 is a computer-readable recording medium, and may be constituted by at least one of an optical disk such as a CD-ROM (Compact Disc ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and so on. Storage 1003 may also be referred to as an auxiliary storage apparatus.

Communication apparatus 1004 is hardware (a transceiver device) for communication between computers via network 2, and is also referred to as, for example, a network device, a network controller, a network card, a communication module, or the like. Communication apparatus 1004 may include a high frequency switch, a duplexer, a filter, a frequency synthesizer, and so on to realize at least one of frequency division duplexing (FDD) and time division duplexing (TDD), for example. A transceiver antenna, an amplifier unit, a transceiver unit, a propagation path interface, and so on may be realized by communication apparatus 1004, for example. The transceiver unit may be implemented as a transmitting unit and a receiving unit that are physically or logically separated from each other. Note that head-mounted display 10 may be connected to network 2 via a device that has a communication function such as a smartphone to perform communication, instead of being directly connected to network 2 to perform communication.

Input apparatus 1005 is an input device (for example, keys, a microphone, a switch, buttons, or various sensors) for accepting input from outside. Output apparatus 1006 is an output device (for example, a speaker, or an LED lamp) that performs output to the outside. Display apparatus 1007 is a display device that includes a liquid crystal element, a liquid crystal drive circuit, and the like, and is used to display a three-dimensional virtual space. Image capture apparatus 1008 is an image capture device that includes an image sensor, and is used to detect a user's line of sight in order to specify an attention position to which the user is paying attention, in a virtual space displayed on display apparatus 1007.

The apparatuses such as processor 1001 and memory 1002 are connected by a bus for information communication. The bus may be constituted by a single bus, or formed using a different bus for each pair of apparatuses.

In addition, head-mounted display 10 may include hardware such as a microprocessor, a digital signal processor (DSP), an ASIC (Application Specific Integrated Circuit), a PLD (Programmable Logic Device), an FPGA (Field Programmable Gate Array), and so on, and part or all of each functional block may be realized by such hardware. For example, processor 1001 may be implemented using at least one of these pieces of hardware.

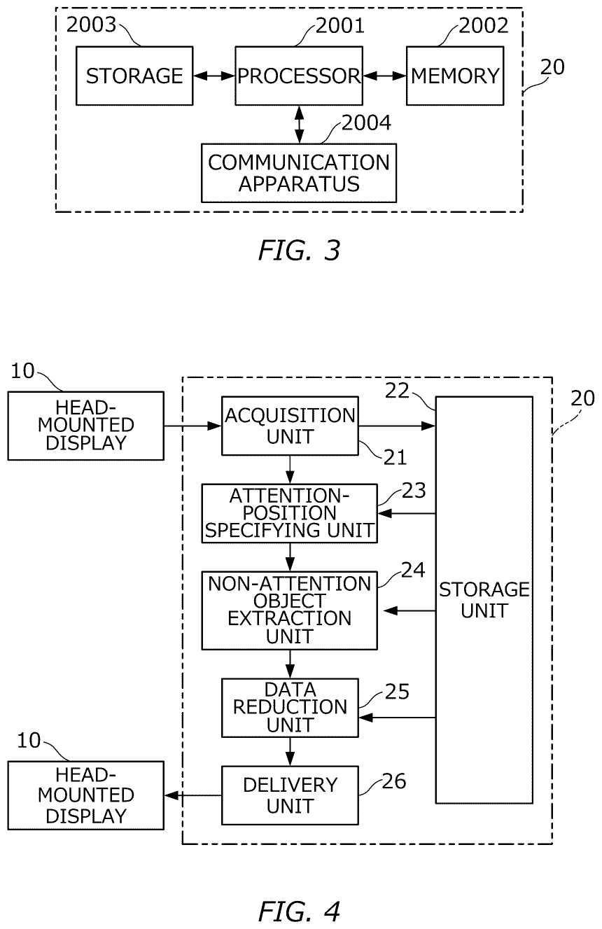

FIG. 3 is a diagram showing a hardware configuration of server apparatus 20. Server apparatus 20 is configured as a computer including processor 2001, memory 2002, storage 2003, communication apparatus 2004, a bus connecting these components, and so on. These apparatuses are powered by a power source (not shown). The hardware configuration of server apparatus 20 may include one or more of each of the apparatuses shown in FIG. 3, and need not include all of the apparatuses. In addition, a plurality of apparatuses that are differently housed may be communicably connected to constitute server apparatus 20.

Each function of server apparatus 20 is realized by loading predetermined software (programs) into hardware such as processor 2001 and memory 2002 so that processor 2001 performs processes to control communication performed by communication apparatus 2004, and control at least one of reading data from and writing data to memory 2002 and storage 2003. Processor 2001, memory 2002, storage 2003, communication apparatus 2004, and a bus connecting these components are respectively similar, as hardware, to processor 1001, memory 1002, storage 1003, communication apparatus 1004, and the bus connecting these components, which have been described with respect to head-mounted display 10, and thus description thereof is omitted.

FIG. 4 is a block diagram showing an example of a functional configuration of server apparatus 20. As shown in FIG. 4, in server apparatus 20, functions such as acquisition unit 21, storage unit 22, attention-position specifying unit 23, non-attention object extraction unit 24, data reduction unit 25, and delivery unit 26 are realized.

Acquisition unit 21 acquires various types of data from head- mounted displays 10. As described above, image capture apparatus 1008 of each head-mounted display 10 captures an image of an eye of the user so as to detect a line of sight and specify an attention position to which the user is paying attention in the virtual space displayed on display apparatus 1007. Processor 1001 of head-mounted display 10 detects the line of sight based on the position of the iris of the eye, whose image has been captured, relative to the inner corner of the eye. If the iris of the left eye is distant from the inner corner of the eye, the user is looking to the left, and if the inner corner and the iris of the left eye are close to each other, the user is looking to the right, for example. Head mounted display 10 transmits the result of detecting the user's line of sight, from communication apparatus 1004 to server apparatus 20 in synchronization with display of the virtual space. Acquisition unit 21 acquires the detection result of the user's line of sight from head-mounted displays 10.

Storage unit 22 stores polygon data for displaying virtual objects included in the virtual space. This polygon data is data for defining the shapes of virtual objects using groups of polygons formed by lines. Three-dimensional coordinates in the virtual space are defined for polygon data corresponding to each virtual object.

Attention-position specifying unit 23 specifies attention positions in the virtual space to which the users pay attention, based on the detection results of the users' lines of sight obtained by acquisition unit 21, and the three-dimensional coordinates in the virtual space displayed on head-mounted displays 10 of the users when the lines of sight are detected. Based on the result of specifying the attention positions, the number of times users pay attention to each virtual object is stored in storage unit 22.

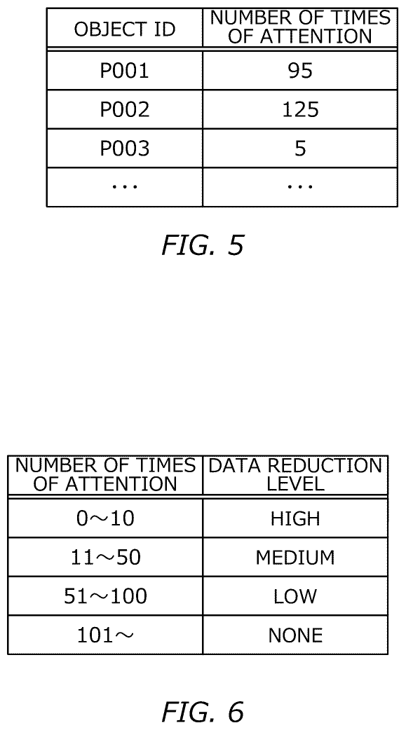

FIG. 5 is a diagram illustrating count data on the number of times of attention stored in storage unit 22. Each object ID refers to identification information for identifying a virtual object, and each number of times of attention is a total value obtained by counting a number of times a plurality of users pays attention to a virtual object. Here, during a certain period in the past (for example, any suitably determined period such as 30 minutes in the past or 24 hours in the past), positions to which the users continued to pay attention for a certain period of time are specified as attention positions. Furthermore, the number of times each virtual object was specified as an attention position is counted, and the number of times of attention corresponding to the object ID of the virtual object is sequentially updated.

Non-attention object extraction unit 24 extracts as a non-attention object, from the virtual objects included in the virtual space, a virtual object for which a number of times of being specified as an attention position does not meet a criterion. The non-attention object extracted here is a virtual object that did not attract much attention, from among the virtual objects displayed to the plurality of users, and thus, processing for displaying the non-attention object at a low resolution by reducing the polygon data or the like is allowed compared with a virtual object that frequently attracted attention, for example. Accordingly, data reduction unit 25 reduces the amount of polygon data for displaying the non-attention object extracted by non-attention object extraction unit 24. Reduction of polygon data mentioned herein is processing that makes it possible to display a virtual object with a smaller amount of data than the polygon data stored in storage unit 22, and uses a technique for reducing the number of polygons, which is called culling or reduction.

Storage unit 22 stores a data reduction table in which the criterion for extracting a non-attention object is written. FIG. 6 is a diagram illustrating this data reduction table. In the example in FIG. 6, if the number of times a virtual object received attention is larger than or equal to 101, no data reduction is performed, that is to say, the virtual object is displayed in accordance with the polygon data stored in storage unit 22. On the other hand, the data reduction level is “low” if the number of times a virtual object received attention is larger than or equal to 51 and smaller than or equal to 100, the data reduction level is “medium” if the number of times a virtual object received attention is larger than or equal to 11 and smaller than or equal to 50, and the data reduction level is “high” if the number of times a virtual object received attention is larger than or equal to 0 and smaller than or equal to 10. That is to say, in the example in FIG. 6, the number of times of attention being 101 times equivalent to a criterion for determining whether or not the virtual object is a non-attention object, and, furthermore, if the number of times of attention is smaller than or equal to 100, the smaller the number of times of attention is, the higher the data reduction level becomes. The smaller the number of times of attention is, the larger the number of polygons that are not to be rendered becomes, for example. Note that, in FIG. 6, there are four data reduction levels, namely “none,” “low,” “medium,” and “high,” but, for example, there may be two data reduction levels, namely “not performed” and “performed,” or there may further be a larger number of levels. There may be any number of data reduction levels.

Delivery unit 26 delivers data for realizing VR (including polygon data) to head-mounted displays 10 via network 2.

### Operations

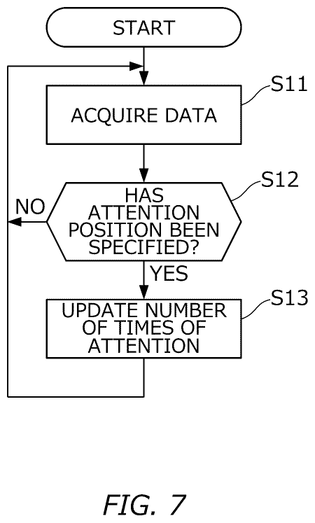

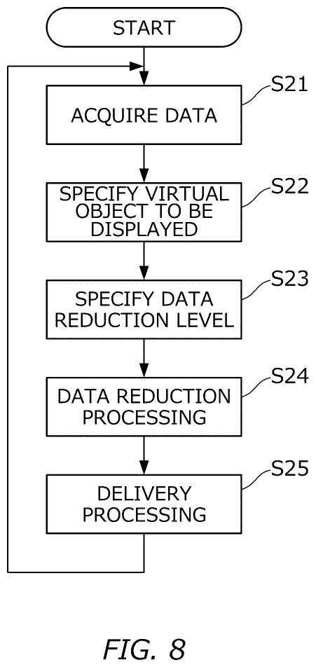

Operations in the present embodiment will be described with reference to FIGS. 7 and 8. First, an operation of updating the number of times of attention that is performed by server apparatus 20 will be described with reference to FIG. 7. When the user starts head-mounted display 10, processor 1001 of head-mounted display 10 performs initial processing for, for example, setting three-dimensional coordinate axes (x, y, and z axes) in which the user's viewpoint serves as an origin and the orientation of head-mounted display 10, and requests data for realizing VR from server apparatus 20. In response, server apparatus 20 transmits polygon data and the like that are based on the above initial setting, to head-mounted display 10. Head mounted display 10 displays a virtual space that includes virtual objects on display apparatus 1007 in accordance with the polygon data acquired via communication apparatus 1004. At this time, image capture apparatus 1008 of head-mounted display 10 repeatedly detects the user's line of sight, and the line-of-sight detection result is transmitted to server apparatus 20 along with a time stamp. Acquisition unit 21 of server apparatus 20 acquires the line-of-sight detection result along with the time stamp (step S11).

Attention-position specifying unit 23 of server apparatus 20 attempts to specify an attention position in the virtual space to which the user is paying attention, based on the detection result of the user's line of sight acquired by acquisition unit 21, and the three-dimensional coordinates in the virtual space that were displayed on head-mounted display 10 when the line of sight specified by the time stamp was detected. Here, a position to which the user continued to pay attention for at least a certain period of time during a certain period in the past is specified as an attention position.

When the user's attention position in the virtual space is specified (step S12; YES), attention position specifying unit 23 specifies a virtual object that was displayed at the attention position, and updates the number of times of attention corresponding to the object ID of the virtual object (step S13).

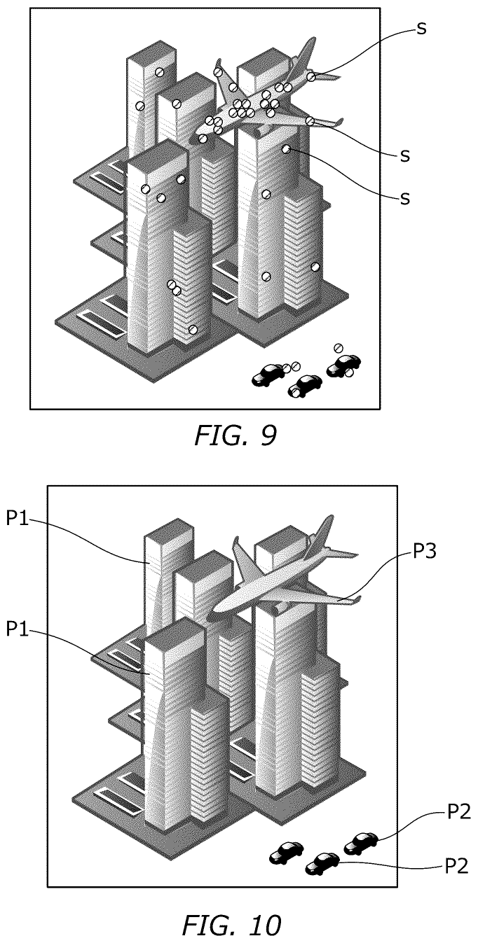

FIG. 9 is a diagram illustrating a distribution of attention positions in a display image on head-mounted display 10. As illustrated in FIG. 9, the distribution of attention positions of a large number of users is biased, and it is possible to distinguish a virtual object for which a degree of attention is relatively high from a virtual object for which a degree of attention is relatively low, based on degrees by which attention positions overlap the virtual objects.

By repeating the above processing, the numbers of times of attention users paid attention to virtual objects are sequentially updated.

Next, a data delivering operation that is performed by server apparatus 20 will be described with reference to FIG. 8. When the user starts head-mounted display 10, processor 1001 of head-mounted display performs initial processing for, for example, setting three-dimensional coordinate axes (x, y, and z axes) in which the user's viewpoint serves as an origin and the orientation of head-mounted display 10, and requests 10 data for realizing VR from server apparatus 20. When acquisition unit 21 of server apparatus 20 acquires this request (step S21), at least one virtual object to be displayed on head-mounted display 10 is specified based on the coordinate axes and the orientation obtained by the above initial processing (step S22).

Next, non-attention object extraction unit 24 of server apparatus references the count data on the number of times of attention (FIG. 5) and the data reduction table (FIG. 6), and specifies a data reduction level of the virtual object specified as an object to be displayed on head-mounted display 10 (step S23). That is to say, non-attention object extraction unit 24 determines that data reduction is not to be performed if the number of times of attention for the virtual object specified as a virtual object to be displayed on head-mounted display 10 is larger than or equal to 101. The data reduction level is “low” if the number of times of attention is larger than or equal to 51 and smaller than or equal to 100, the data reduction level is “medium” if the number of times of attention is larger than or equal to 11 and smaller than or equal to 50, and the data reduction level is “high” if the number of times of attention is larger than or equal to 0 and smaller than or equal to 10.

Next, data reduction unit 25 of server apparatus 20 performs processing for reducing the amount of polygon data for displaying the non-attention object extracted by non-attention object extraction unit 24, in accordance with the data reduction level (step S24). Here, the higher the data reduction level for the virtual object is, the larger the number of polygons that are to be reduced for the virtual object becomes.

Delivery unit 26 of server apparatus 20 then delivers polygon data subjected to data reduction processing, to head-mounted display 10 via network 2 (step S25).

FIG. 10 is a diagram illustrating a display image after data reduction, displayed on head-mounted display 10. In FIG. 10, regarding virtual objects P1 resembling buildings, virtual objects P2 resembling automobiles, and virtual object P3 resembling an aircraft, the data reduction level increases in order of the virtual object P3 for which the number of times of attention is relatively large, the virtual objects P2 for which the number of times of attention is moderate, and the virtual objects P1 for which the number of times of attention is relatively small.

The processing illustrated in FIG. 7 and the processing illustrated in FIG. 8, which have been described above, are executed at the same time. Note that, at the initial point of time when delivery of polygon data is started, the number of times of attention are not counted, and thus, the data reduction levels of all of the virtual objects are “high” according to the data reduction table. In view of this, a configuration may be adopted in which, at the initial point of time when delivery of polygon data is started, all of the virtual objects are displayed at a high resolution, for example, by setting the data reduction levels of the virtual objects to “not performed,” or, for example, the data reduction levels of all of the virtual objects are set to “low” so as to prevent occurrence of a delay in display and the like.

According to the embodiment described above, in the virtual space that a plurality of users can join, a plurality of virtual objects is displayed based on data reduced in accordance with the number of times of attention, and thus a likelihood of occurrence of a delay in display or the like is reduced, realizing smooth display overall.

### MODIFICATIONS

The present invention is not limited to the above-described embodiment. The above-described embodiment may be modified as described below. In addition, two or more of the modifications described below may be implemented in combination.

### Modification 1

A configuration may be adopted in which data reduction unit 25 does not perform data reduction for a virtual object provided with a specific attribute, from among the virtual objects included in the virtual space, regardless of a number of times of attention for the virtual object. The virtual object provided with a specific attribute is a virtual object that moves or a virtual object for advertisement, for example. Metadata indicating that data reduction is not to be performed is provided to polygon data for such a virtual object in advance by a system administrator or the like. Data reduction unit 25 excludes a virtual object provided with such metadata, from non-attention object extraction targets, and does not perform data reduction for the virtual object. Accordingly, a virtual object that the user wants to display at a high resolution with an intended number of polygons can be displayed as is.

### Modification 2

When virtual objects are specified by dividing the numbers of times the respective virtual objects received attention by given conditions, and the virtual space is displayed under each of the conditions, non-attention objects may be extracted in accordance with the numbers of times of attention specified under the condition.

### Modification 2-1

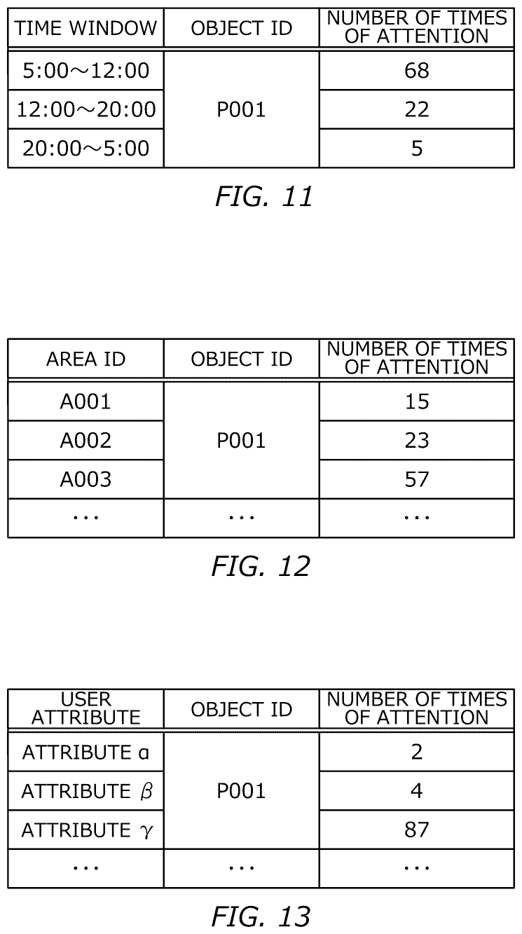

One of the conditions for classifying the numbers of times of attention mentioned herein is a condition that relates to time defined in the virtual space. FIG. 11 is a diagram illustrating count data on the numbers of times of attention according to the present modification. Here, three time windows “5:00 to 12:00,” “12:00 to 20:00,” and “20:00 to 5:00,” which are time conditions related to time, are set, and the numbers of times a virtual object received attention are counted. In the example in the figure, the number of times of attention for the virtual object of the object ID “P001” included in the virtual space is “68” times in the time window “5:00 to 12:00” in the virtual space, “22” times in the time window “12:00 to 20:00” in the virtual space, and “5” times in the time window “20:00 to 5:00” in the virtual space. Then, when the virtual space is displayed on head-mounted displays 10, extraction of non-attention objects in accordance with the number of times of attention being “68” times is performed if the time in the virtual space at that moment is included in “5:00 to 12:00,” extraction of non-attention objects in accordance with the number of times of attention being “22” times is performed if the time in the virtual space at that moment is included in “12:00 to 20:00,” and extraction of non-attention objects in accordance with the number of times of attention being “5” times is performed if the time in the virtual space at that moment is included in “20:00 to 5:00.”

As described above, a configuration may be adopted in which, in a case where time is defined in the virtual space, attention-position specifying unit 23 specifies attention positions based on different time-related conditions, and non-attention object extraction unit 24 extracts non-attention objects based on the different time-related conditions. It can be conceived that a virtual object to which users are likely to pay attention may differ in accordance with a time in the virtual space, and, for example, in the virtual space, buildings with neon signs that light up and the like are likely to attract attention at night, while pedestrians, stores, and the like are likely to attract attention during the daytime. According to the present modification, non-attention objects can be extracted in accordance with time-related conditions as described above.

### Modification 2-2

In addition, one of the conditions for classifying the numbers of times of attention is a condition related to position defined in the virtual space. FIG. 12 is a diagram illustrating count data on the numbers of times of attention according to the present modification. Here, the virtual space is divided into several areas, and, for respective area IDs provided to the areas, the numbers of times a virtual object received attention, with positions in the areas representing users' viewpoints, are counted. In the example in the figure, as the numbers of times of attention for the virtual object of the object ID “P001” included in the virtual space, the number of times positions in the area of an area ID “A001” received attention as users' viewpoints is “15” times, the number of times positions in the area of an area ID “A002” received attention as users' viewpoints is “23” times, and the number of times positions in the area of an area ID “A003” received attention as users' viewpoints is “57” times. Then, when the virtual space is displayed on head-mounted displays 10, extraction of non-attention objects in accordance with the number of times of attention being “15” times is performed if the positions of the viewpoints of the users that view display of the virtual space at this time are included in the area of the area ID “A001,” extraction of non-attention objects in accordance with the number of times of attention being “23” times is performed if the positions of the viewpoints of the users that view display of the virtual space at this time are included in the area of the area ID “A002,” and extraction of non- attention objects in accordance with the number of times of attention being “57” times is performed if the positions of the viewpoints of the users that view display of the virtual space at this time are included in the area of the area ID “A003.”

As described above, a configuration may be adopted in which, in a case where position is defined in the virtual space, attention-position specifying unit 23 specifies attention positions for each area that includes users' viewpoints in the virtual space, and non-attention object extraction unit 24 extracts non-attention objects for each area that includes users' viewpoints in the virtual space. It can be conceived that a degree to which even the same virtual object receives attention may differ depending on the position of the viewpoint of a user who views the virtual object, and, for example, in an area near a virtual object corresponding to a famous landmark, the landmark is highly likely to attract attention, whereas, in an area from which the landmark is visible but is distant from the landmark, a virtual object other than the landmark is likely to attract attention. According to the present modification, it is possible to extract non-attention objects based on the positions of viewpoints of users as described above.

### Modification 2-3

In addition, one of the conditions for classifying the numbers of times of attention is a condition related to attributes of users that view display of the virtual space. FIG. 13 is a diagram illustrating count data on the numbers of times of attention according to the present modification. Here, users are grouped based on several user attributes, and, for each of the user attributes, the number of times the users corresponding to the user attribute paid attention to a virtual object is counted. In the example in the figure, the number of times the users of a user attribute “attribute α” paid attention to the virtual object of the object ID “P001” included in the virtual space is “2” times, the number of times the users of a user attribute “attribute 6” paid attention to the virtual object of the object ID “P001” is “4” times, and the number of times the users of a user attribute “attribute γ” paid attention to the virtual object of the object ID “P001” is “87” times. Then, when the virtual space is displayed on head-mounted displays 10, extraction of non-attention objects in accordance with the number of times of attention being “2” times is performed if the user attribute of the users who view display of the virtual space at this time is “attribute α,” extraction of non-attention objects in accordance with the number of times of attention being “4” times is performed if the user attribute of the users who view display of the virtual space at this time is “attribute β,” and extraction of non-attention objects in accordance with the number of times of attention being “87” times is performed if the user attribute of the users who view display of the virtual space at this time is “attribute γ.”

As described above, a configuration may be adopted in which attention-position specifying unit 23 specifies positions of attention for each user attribute, and non-attention object extraction unit 24 extracts non-attention objects for each user attribute. It can be conceived that, for example, a virtual object to which a male user is likely to pay attention and a virtual object to which a female user is likely to pay attention may differ, and a virtual object to which users of a younger age group are likely to pay attention and a virtual object to which users of an older age group are likely to pay attention may differ. According to the present modification, non-attention objects can be extracted based on attributes of users as described above.

### Modification 3

The present invention is not limited to VR illustrated in the embodiment, and may be used for general XR that includes AR, MR, and the like.

### Other Modifications

The block diagrams used in the description of the above embodiment show blocks in functional units. These functional blocks (components) are realized by a combination of hardware and/or software. Furthermore, there are no particular limitations on the means for realizing the functional blocks. In other words, the functional blocks may be realized by one physically and/or logically combined apparatus, or by a plurality of physically and/or logically separated apparatuses that are connected directly and/or indirectly (for example, in a wired and/or wireless manner). At least some of the functions of server apparatus 20 may be implemented in an external computer, for example. In the above embodiment, for example, head-mounted display 10 performs an operation related to image display in cooperation with server apparatus 20, but head-mounted display 10 may perform an operation related to image display in a standalone manner without being controlled by server apparatus 20. In this case, head-mounted display 10 acquires data equivalent to the number-of-times of attention count table from server apparatus 20, and performs data reduction processing on virtual objects based on the data.

The aspects/embodiments described in the present description may be applied to a system that uses LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-Wide Band), or Bluetooth (registered trademark), or another appropriate system, and/or a next- generation system that is an extension of any of these systems.

The orders in the processing procedures, sequences, flowcharts, and the like of the aspects/embodiments described in the present description may be changed as long as no contradictions arise. For example, the methods described in the present description show various step elements in an exemplified order, but are not limited to the specific order that is shown. The aspects/embodiments described in the present description may be used alone or in combination, or may be switched when they are implemented. Furthermore, the notification of predetermined information (for example, notification of “being X”) is not limited to being performed explicitly, and may also be performed implicitly (for example, notification of the predetermined information is not performed).

The terms “system” and “network” as used in the present description are interchangeable.

The information and the parameters described in the present description may also be expressed as absolute values, as relative values with respect to a predetermined value, or as another type of information corresponding thereto. Wireless resources may be instructed using indexes, for example.

Names that are used for the above parameters are not limited. Furthermore, formulas and the like that use these parameters may be different from those explicitly disclosed in the present description. Various channels (for example, PUCCH and PDCCH) and information elements (for example, TPC) can be identified by any suitable names, and names allocated to these various channels and information elements are not limited.

The term “determining” used in the present description may encompass various types of operations. For example, the term “determining” can include a case where judging, calculating, computing, processing, deriving, investigating, looking up (for example, looking up a table, a database, or another data structure), or ascertaining is regarded as “determining.” Furthermore, the term “determining” can include a case where receiving (for example, receiving information), transmitting (for example, transmitting information), inputting, outputting, or accessing (for example, accessing data in the memory) is regarded as “determining.” Furthermore, the term “determining” can include a case where resolving, selecting, choosing, establishing, or comparing is regarded as “determining.” In other words, the term “determining” can include a case where an operation is regarded as “determining.”

The present invention may be provided as an information processing method that includes processing steps performed by head-mounted display 10. In addition, the present invention may be provided as a program that is executed in head-mounted display 10. The program may be provided in a mode of being recorded on a recording medium such as an optical disk, or may be provided in a mode of being downloaded to a computer via a network such as the Internet and being installed in the computer to become usable, for example.

Software, instructions, and the like may also be transmitted/received via a transmission medium. For example, if software is transmitted from a website, a server, or another remote source using a wired technology such as a coaxial cable, an optical fiber cable, a twisted pair wire, or a digital subscriber line (DSL), and/or a wireless technology using infrared light, radio waves, microwaves, or the like, the definition of the transmission medium includes the wired technology and/or the wireless technology.

Information, signals, and the like described in the present description may also be expressed using any of various different technologies. For example, data, an instruction, a command, information, a signal, a bit, a symbol, a chip, and the like mentioned throughout the entire description above may also be expressed as an electric voltage, an electric current, an electromagnetic wave, a magnetic field or a magnetic particle, an optical field or a photon, or a combination thereof.

Terms described in the present description and/or terms required for understanding the present description may be replaced with terms that have the same or a similar meaning. Channels and/or symbols may be signals, for example. In addition, a signal may be a message. In addition, a component carrier (CC) may be referred to as carrier frequency, cell, or the like.

Any references to elements used in the present description with designations such as “first” and “second” do not generally limit a number of such elements or an order thereof. Such designations may be used in the present description as a convenient way to distinguish two or more elements. Accordingly, references to first and second elements are not intended to mean that only two elements can be employed, or that the first element is required to come before the second element.

“Means” in the configurations of the above-described apparatuses may be replaced with “unit,” “circuit,” “device,” or the like.

The terms “including,” “comprising,” and variations thereof are intended to be comprehensive as used in the present description or the claims, with a meaning similar to the phrase “being provided with.” Furthermore, the term “or” used in the present description or the claims is not intended to be exclusively OR.

In the entirety of the present disclosure, when articles are included via translation, for example, as “a,” “an,” and “the” in English, such articles also denote plural form unless it is clear otherwise from the context.

While the present invention has been described in detail, it will be obvious to those skilled in the art that the present invention is not limited to the embodiments described in the present description. The present invention can be implemented with altered and modified aspects without departing from the spirit and scope of the present invention defined in the claims. Accordingly, the present description aims to illustrate examples and is not intended to restrict the present invention.

### REFERENCE SIGNS LIST

1 . . . Information processing system,
2 . . . Network,
10 . . . Head mounted display,
20 . . . Server apparatus,
21 . . . Acquisition unit,
22 . . . Storage unit,
23 . . . Attention-position specifying unit,
24 . . . Non-attention object extraction unit,
25 . . . Data reduction unit,
26 . . . Delivery unit,
1001 . . . Processor,
1002 . . . Memory,
1003 . . . Storage,
1004 . . . Communication apparatus,
1005 . . . Input apparatus,
1006 . . . Output apparatus,
1007 . . . Display apparatus,
1008 . . . Image capture apparatus,
2001 . . . Processor,
2002 . . . Memory,
2003 . . . Storage,
2004 . . . Communication apparatus,
s . . . Attention position,
P1, P2, P3 . . . Virtual object

1. An information processing apparatus comprising:
an attention-position specifying unit that specifies, in a virtual space that includes virtual objects displayed on user terminals, an attention position to which users using the user terminals pay attention;
a non-attention object extraction unit that extracts as a non-attention object from the virtual objects, a virtual object for which a number of times of being specified as the attention position does not meet a criterion; and
a data reduction unit that reduces an amount of data for displaying the extracted non-attention object on the user terminals.

2. The information processing apparatus according to claim 1,
wherein the attention-position specifying unit specifies as the attention position a position to which each of the users continuously pays attention for at least a certain period of time, and
the non-attention object extraction unit counts the number of times each of the virtual objects is specified as the attention position, in a certain past period, and extracts as the non-attention object a virtual object for which the counted number of times does not meet the criterion.

3. The information processing apparatus according to claim 1,
wherein the data reduction unit does not perform data reduction on a virtual object provided with a specific attribute, from among the virtual objects.

4. The information processing apparatus according to claim 3,
wherein the virtual object provided with the specific attribute is a moving object or an object related to advertisement.

5. The information processing apparatus according to claim 1,
wherein time is defined in the virtual space,
the attention-position specifying unit specifies the attention position based on different time-related conditions, and
the non-attention object extraction unit extracts the non-attention object based on the different time-related conditions.

6. The information processing apparatus according to claim 1,
wherein position is defined in the virtual space,
the attention-position specifying unit specifies the attention position for each area that includes a user's viewpoint in the virtual space, and
the non-attention object extraction unit extracts the non-attention object for each area.

7. The information processing apparatus according to claim 1,
wherein the attention-position specifying unit specifies the attention position for each of user attributes of the users, and
the non-attention object extraction unit extracts the non-attention object for each of the user attributes.
